(19) United States
(12) Patent Application Publication
(10) Pub. No.: US 2025/0379299 A1
(43) Pub. Date: Dec. 11, 2025

(54) SECONDARY BATTERY AND MANUFACTURING METHOD OF THE SAME

(71) Applicant: SK On Co., Ltd., Seoul (KR)

(72) Inventor: Hoemin Cheong, Daejeon (KR)

(21) Appl. No.: 19/227,502

(22) Filed: Jun. 4, 2025

(30) Foreign Application Priority Data
Jun. 11, 2024 (KR) 10-2024-0075559

(51) Int. Cl. H01M 50/131; H01M 50/107; H01M 50/119; H01M 50/169

(52) U.S. Cl. CPC H01M 50/131; H01M 50/107; H01M 50/119; H01M 50/169

(57) ABSTRACT

The present disclosure relates to a secondary battery and a manufacturing method of the secondary battery. The secondary battery according to an embodiment of the present disclosure includes a case including a cylindrical side wall portion having a receiving space therein, a closed end portion formed at one end of the side wall portion, and an opening provided at another end of the side wall portion; and an electrode assembly received in the receiving space, wherein the side wall portion includes a first region including the one end, a second region including the other end, and a third region including a region other than the first region and the second region, and wherein mechanical strength of the first region is higher than mechanical strength of the third region.

### CROSS-REFERENCE TO RELATED PATENT APPLICATION

The present disclosure claims priority under 35 U.S.C. § 119(a) to Korean patent application number 10-2024-0075559, filed on Jun. 11, 2024, the entire disclosure of which is incorporated herein by reference.

### BACKGROUND OF THE INVENTION

### 1. Field

Various embodiments of the present disclosure generally relate to a secondary battery and a manufacturing method of the same, and more particularly, to a secondary battery having improved mechanical properties and a method of manufacturing the same.

### 2. Description of the Related Art

Secondary batteries can be classified into can-type secondary batteries and pouch-type secondary batteries depending on a shape of a case. In addition, can-type secondary batteries can be further classified into cylindrical secondary batteries and prismatic secondary batteries depending on a shape of a can (or case).

With respect to cylindrical secondary batteries, battery cells are becoming larger, and high-nickel cathodes and/or silicon-based anodes are being employed to further improve their high capacity characteristics.

However, in such a case, the pressure that can be generated inside the case increases compared to the conventional secondary batteries, and if the mechanical rigidity of a battery casing (case) of the secondary batteries is not supported, the structural deformation of the battery casing that cannot withstand the internal pressure can cause fatal safety problems such as gas leaks.

### SUMMARY OF THE INVENTION

According to an aspect of the present disclosure, a case for a secondary battery with improved mechanical properties, in particular, a case for a second battery in which the mechanical rigidity of opposite ends thereof is secured, and a secondary battery with the improved safety and stability by including the same may be provided.

According to another aspect of the present disclosure, a method of efficiently manufacturing a case for a secondary battery in which the mechanical rigidity of opposite ends thereof is secured and a secondary battery including the same may be provided.

Various embodiments of the present disclosure may be widely applied in the green technology fields such as electric vehicles, battery charging stations, energy storage systems (ESSs), and other technologies using batteries such as photovoltaics and wind power. In addition, various embodiments of the present disclosure may also be used for eco-friendly mobility, including electric and hybrid vehicles, to reduce air pollution and greenhouse gas emissions to prevent or mitigate climate change.

A secondary battery according to an embodiment of the present disclosure includes: a case including a cylindrical side wall portion having a receiving space therein, a closed end portion formed at one end of the side wall portion, and an opening provided at another end of the side wall portion; and an electrode assembly received in the receiving space, wherein the side wall portion includes a first region including the one end, a second region including the other end, and a third region including a region other than the first region and the second region, and wherein mechanical strength of the first region is higher than mechanical strength of the third region.

In the secondary battery according to an embodiment, the side wall portion may include a carbon steel material having a carbon content of 0.8 wt % or less.

In the secondary battery according to an embodiment, the mechanical strength may include yield strength, and yield strength of the first region may be 1.2 times or more yield strength of the third region.

In the secondary battery according to an embodiment, the yield strength of the first region may be 3.0 times or more the yield strength of the third region.

In the secondary battery according to an embodiment, the mechanical strength may include tensile strength, and tensile strength of the first region may be 1.1 times or more tensile strength of the third region.

In the secondary battery according to an embodiment, the tensile strength of the first region may be 2.0 times or more the tensile strength of the third region.

The secondary battery according to an embodiment may further include a cap plate sealing the opening, the cap plate may be welded and coupled to the case, and mechanical strength of each of the first region and the second region may be higher than the mechanical strength of the third region.

A method of manufacturing a secondary battery according to an embodiment of the present disclosure includes: a preparation step of preparing a case including a cylindrical side wall portion having a receiving space therein, a closed end portion formed at one end of the side wall portion, and an opening provided at another end of the side wall portion; a heat treatment step of performing heat treatment on a first region including the one end of the side wall portion of the case; and a cooling step of cooling the case on which the heat treatment is performed in the heat treatment step.

In the method of manufacturing the secondary battery according to an embodiment, the side wall portion may include a carbon steel material having a carbon content of 0.8 wt % or less.

In the method of manufacturing the secondary battery according to an embodiment, the heat treatment step may include a heating step of heating the first region until a reference temperature is reached, and the reference temperature may be 250° C. to 500° C.

In the method of manufacturing the secondary battery according to an embodiment, the heat treatment step may further include a holding step of leaving the first region, heated to the reference temperature in the heating step, to stand, and the holding step may be performed for 1 to 10 seconds.

In the method of manufacturing the secondary battery according to an embodiment, in the cooling step, the case may be cooled at a cooling rate of 5° C./sec to 500° C./sec.

In the method of manufacturing the secondary battery according to an embodiment, in the cooling step, the case may be cooled by a water-cooling method.

In the method of manufacturing the secondary battery according to an embodiment, in the heat treatment step, heat treatment may be performed on both the first region including the one end of the side wall portion of the case and the second region including the other end of the side wall portion of the case.

The method of manufacturing the secondary battery according to an embodiment may further include a receiving step of receiving an electrode assembly wound in a form of a roll in the receiving space of the case cooled in the cooling step.

According to an aspect of the present disclosure, a case for a secondary battery with improved mechanical properties, in particular, a case for a second battery in which the mechanical rigidity of opposite ends thereof is secured, and a secondary battery with the improved safety and stability by including the same may be provided.

According to another aspect of the present disclosure, a method of efficiently manufacturing a case for a secondary battery in which the mechanical rigidity of opposite ends thereof is secured and a secondary battery including the same may be provided.

Various embodiments of the present disclosure may be widely applied in the green technology fields such as electric vehicles, battery charging stations, energy storage systems (ESSs), and other technologies using batteries such as photovoltaics and wind power. In addition, various embodiments of the present disclosure may also be used for eco-friendly mobility, including electric and hybrid vehicles, to reduce air pollution and greenhouse gas emissions to prevent or mitigate climate change.

### BRIEF DESCRIPTION OF THE DRAWINGS

FIG. 1 is a diagram of an example of a case of a secondary battery according to an embodiment of the present disclosure viewed from one direction;

FIG. 2 is a diagram of an example of a case of a secondary battery according to an embodiment of the present disclosure viewed from another direction;

FIG. 3 is a diagram of an example of a secondary battery according to an embodiment of the present disclosure viewed from one direction;

FIG. 4 is a diagram of an example of a secondary battery according to an embodiment of the present disclosure viewed from another direction;

FIG. 5 is a flowchart illustrating a method of manufacturing a secondary battery according to an embodiment of the present disclosure;

FIG. 6 is a diagram illustrating an embodiment of a heat treatment step; and

FIG. 7 is a diagram illustrating another embodiment of the heat treatment step.

### DETAILED DESCRIPTION

Embodiments described herein may be modified in many other ways, so that the technology according to an embodiment is not limited to the embodiments described herein. Further, throughout the specification, references to “including,” “comprising,” “containing,” or “having” any component are not intended to exclude other components, but rather to indicate that other components may be further included unless otherwise stated, and are not intended to exclude elements, materials, or processes not further enumerated.

As used herein, equal or uniform may mean identical or uniform to each other within acceptable tolerances unless otherwise specified. For example, equal in composition or physical property measurements may mean that the two objects being compared are identical within tolerances, as well as being exactly the same. Having the same physical property measurements may mean that the difference in the measurements between the objects is approximately less than 5%, specifically less than 3%, or more specifically less than 1%.

As used herein, that angles formed by two objects are perpendicular or parallel to each other may include not only being geometrically perpendicular or parallel, but also being within slight tolerances.

As used herein, numerical ranges include upper and lower bounds and all values within them, increments logically derived from the shape and width of the range being defined, all doubly bounded values, upper and lower bounds of numerical ranges bounded in different forms, and all possible combinations thereof.

Unless otherwise defined herein, “about” may be considered to be a value within 30%, 25%, 20%, 15%, 10%, or 5% of the stated value.

The use of the terms “first,” “second,” “third,” and the like before any component in this specification is intended to avoid confusion as to the component to which it refers, and is not intended to indicate any order, importance, or master-slave relationship between the components. For example, an embodiment may include only the second component without the first component.

As used herein, the term “electrically connected” may mean, without limitation, any connection method by which a plurality of objects may be connected to each other so as to be in electrical communication with each other.

A configuration defined herein as a “portion” may mean, without limitation, a single component or a set of two or more identical or similar components having common functional aspects.

As used herein, “arranged” may mean, without limitation, a positional relationship by which one object may be positioned adjacent to another object. By way of non-limiting example, it may mean coating one object with another object, adhering one object with another through an adhesive material, fusing one object with another by applying heat, pressure, or the like, or simply positioning one object so that at least a portion of one object abuts at least a portion of another object in any space.

As used herein, the term “secondary battery” may refer to a battery which generates electrical energy through oxidation and reduction reactions when ions, specifically cations such as lithium ions, are inserted into and extracted from a cathode and an anode.

Hereinafter, embodiments of the present disclosure will be described in detail. However, this is by way of example only and the invention is not limited to the specific embodiments described herein.

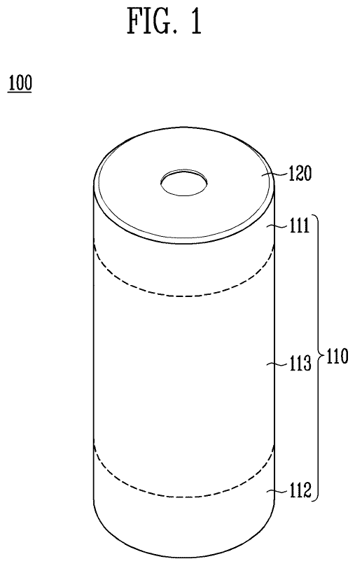

FIG. 1 is a diagram of an example of a case 100 of a secondary battery 10 according to an embodiment of the present disclosure viewed from one direction.

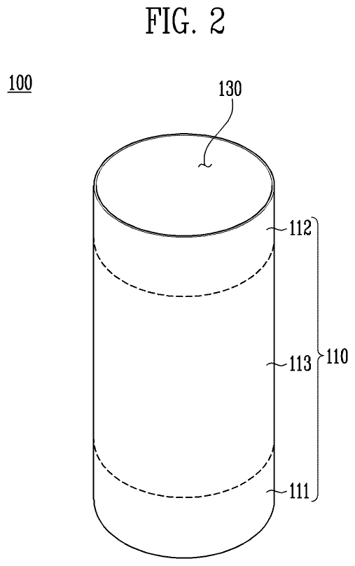

FIG. 2 is a diagram of an example of the case 100 of the secondary battery 10 according to an embodiment of the present disclosure viewed from another direction.

The secondary battery 10 according to an embodiment of the present disclosure includes: the case 100 including a cylindrical side wall portion 110 having a receiving space therein, a closed end portion 120 formed at one end of the side wall portion 110, and an opening 130 provided at the other end of the side wall portion 110; and an electrode assembly (not shown) received in the receiving space. The side wall portion 110 includes a first region 111 including one end, a second region 112 including the other end, and a third region 113 including a region other than the first region 111 and the second region 112, and the mechanical strength of the first region 111 may be higher than the mechanical strength of the third region 113.

Referring to FIGS. 1 and 2, in an embodiment, the case 100 may include the cylindrical side wall portion 110 having the receiving space therein, the closed end portion 120 formed at one end of the side wall portion 110, and the opening 130 provided at the other end of the side wall portion 110.

In an embodiment, the side wall portion 110 may be formed in a cylindrical shape. In a specific embodiment, the side wall portion 110 may be formed in a cylindrical shape having a receiving space therein. The side wall portion 110 may receive the electrode assembly (not shown) in an internal receiving space.

Referring to FIG. 1, in an embodiment, the closed end portion 120 may be formed at one end of the side wall portion 110. In a specific embodiment, the closed end portion 120 may be formed at one end of the side wall portion 110 in a direction perpendicular to an extension direction of the side wall portion 110, and may be formed to seal one end of the side wall portion 110. One end may mean one of opposite ends of the side wall portion 110 formed in a cylindrical shape with respect to the extension direction of the side wall portion 110.

In an embodiment, the closed end portion 120 may extend from one end of the side wall portion 110. That is, in this case, the closed end portion 120 may be integrally formed with the side wall portion 110.

Alternatively, in an embodiment, the closed end portion 120 may be formed at one end of the side wall portion 110, but may be formed separately from the side wall portion 110. In such an embodiment, the closed end portion 120 may be formed in a structure separable from the side wall portion 110.

In an embodiment, the closed end portion 120 may define a cap assembly 125 together with an insulating member and an electrode terminal 121 to be described below, which will be described below.

Referring to FIG. 2, in an embodiment, the opening 130 may be provided at the other end of the side wall portion 110. The other end of the side wall portion 110 formed in a cylindrical shape may mean one end other than one end of opposite ends with respect to the extension direction of the side wall portion 110.

In an embodiment, the opening 130 may be in communication with the receiving space. Therefore, the electrode assembly (not shown) may be received in the case 100 through the opening 130. The opening 130 may be sealed by a cap plate 140 to be described below. When the opening 130 is sealed by the cap plate 140, the receiving space may be sealed from the outside by the side wall portion 110, the closed end portion 120, and the cap plate 140.

In an embodiment, the side wall portion 110 may include the first region 111 including one end, the second region 112 including the other end, and the third region 113 including a region other than the first region 111 and the second region 112.

Referring to FIGS. 1 and 2, in an embodiment, the first region 111 may mean a region adjacent to one end of the side wall portion 110 while including one end in the side wall portion 110. That is, the first region 111 may mean one end of the side wall portion 110 and a region adjacent thereto with respect to the extension direction of the side wall portion 110. The first region 111 may mean a region in contact with the closed end portion 120 in the side wall portion 110 and a region adjacent thereto.

In an embodiment, the first region 111 may be formed to be 25% or less of the total area of the side wall portion 110. In a specific embodiment, the first region 111 may be formed to be 20% or less of the total area of the side wall portion 110, and in a more specific embodiment, the first region 111 may be 16% or less of the total area of the side wall portion 110.

Referring again to FIGS. 1 and 2, in an embodiment, the second region 112 may mean a region adjacent to the other end of the side wall portion 110 while including the other end in the side wall portion 110. That is, the second region 112 may mean the other end of the side wall portion 110 and a region adjacent thereto with respect to the extension direction of the side wall portion 110. The second region 112 may mean a region opposite to the first region 111 with respect to the extension direction of the side wall portion 110. The second region 112 may also mean a region in contact with the opening 130 in the side wall portion 110 and a region adjacent thereto.

In an embodiment, the second region 112 may be formed to be 25% or less of the total area of the side wall portion 110. In a specific embodiment, the second region 112 may be formed to be 20% or less of the total area of the side wall portion 110, and in a more specific embodiment, the second region 112 may be 16% or less of the total area of the side wall portion 110.

In an embodiment, the first region 111 and the second region 112 may be formed to have the same area. Alternatively, the first region 111 and the second region 112 may be formed to have different areas.

Referring again to FIGS. 1 and 2, in an embodiment, the third region 113 may include a region other than the first region 111 and the second region 112. In an embodiment, the third region 113 may mean any region other than the first region 111 and the second region 112 in the side wall portion 110. In a specific embodiment, the third region 113 may mean any region located between the first region 111 and the second region 112. That is, the third region 113 may mean any region located in a relatively intermediate portion other than the first region 111 and the second region 112 located at opposite ends of the side wall portion 110.

In an embodiment, the side wall portion 110 may include a carbon steel material having a carbon content of 0.8 wt % or less. In a specific embodiment, the side wall portion 110 may include a carbon steel material having a carbon content of 0.65 wt % or less. The carbon steel material may include a low-carbon steel material having a carbon content of 0.02 wt % to 0.8 wt %, specifically 0.02 wt % to 0.65 wt %. The carbon steel material may include an ultra-low carbon steel material having a carbon content of 0.02 wt % to 0.2 wt %.

In an embodiment, the side wall portion 110 may include a plated carbon steel material. The plating treatment is for preventing corrosion of the side wall portion 110, and a known technique may be employed without limitation as long as it corresponds to plating treatment of carbon steel for corrosion prevention. According to an embodiment, the side wall portion 110 may include a nickel-plated carbon steel material, but is not necessarily limited thereto.

When the side wall portion 110 includes a carbon steel material having a carbon content of 0.8 wt % or less, the mechanical rigidity may be somewhat inferior, but the processability may be excellent due to the high ductility.

In an embodiment, when the closed end portion 120 is integrally formed with the side wall portion 110 as described above, the side wall portion 110 and the closed end portion 120 may include the same material. In an embodiment, as described above, when the closed end portion 120 is formed in a structure separable from the side wall portion 110, the side wall portion 110 and the closed end portion 120 may include different materials. In contrast, the side wall portion 110 and the closed end portion 120 may also include the same material even when the closed end portion 120 is separable from the side wall portion 110.

In an embodiment, the mechanical strength of the first region 111 may be higher than that of the third region 113.

In an embodiment, the mechanical strength includes the yield strength, and the yield strength of the first region 111 may be 1.2 times or more the yield strength of the third region 113.

In this specification, the yield strength may mean a maximum stress value which can be applied to a material without causing the plastic deformation of the material. In this specification, the yield strength may be measured by, for example, the method of ASTM E8/E8M using, for example, a Universal Testing Machine (UTM).

In an embodiment, the yield strength of the first region 111 may be 3.0 times or more the yield strength of the third region 113. In a specific embodiment, the yield strength of the first region 111 may be 3.3 times or more the yield strength of the third region 113.

In an embodiment, the yield strength of the first region 111 may be greater than or equal to 300 MPa. In a specific embodiment, the yield strength of the first region 111 may be greater than or equal to 330 MPa. In a more specific embodiment, the yield strength of the first region 111 may be greater than or equal to 800 MPa, and in a still more specific embodiment, the yield strength of the first region 111 may be greater than or equal to 850 MPa.

In an embodiment, the yield strength of the third region 113 may be less than or equal to 300 MPa. In a specific embodiment, the yield strength of the third region 113 may be less than or equal to 260 MPa.

In an embodiment, the mechanical strength includes the tensile strength, and the tensile strength of the first region 111 may be 1.1 times or more the tensile strength of the third region 113.

In this specification, the tensile strength may mean a maximum tensile stress value which can be applied to a material without causing breakage of the material. In this specification, the tensile strength may be measured by, for example, the method of ASTM E8/E8M using, for example, a Universal Testing Machine (UTM).

In an embodiment, the tensile strength of the first region 111 may be 2.0 times or more the tensile strength of the third region 113. In a specific embodiment, the tensile strength of the first region 111 may be 2.1 times or more the tensile strength of the third region 113.

In an embodiment, the tensile strength of the first region 111 may be greater than or equal to 500 MPa. In a specific embodiment, the tensile strength of the first region 111 may be greater than or equal to 550 MPa. In a more specific embodiment, the tensile strength of the first region 111 may be greater than or equal to 850 MPa, and in a still more specific embodiment, the tensile strength of the first region 111 may be greater than or equal to 890 MPa.

In an embodiment, the tensile strength of the third region 113 may be less than or equal to 450 MPa. In a specific embodiment, the tensile strength of the third region 113 may be less than or equal to 420 MPa.

In an embodiment, the elongation of the first region 111 may be less than 25%. In a specific embodiment, the elongation of the first region 111 may be less than 20%, and in a more specific embodiment, the elongation of the first region 111 may be less than 16%. The elongation of the third region 113 may be greater than or equal to 30%.

In an embodiment, the mechanical strength of the second region 112 may be greater than that of the third region 113.

In an embodiment, the mechanical strength includes the yield strength, and the yield strength of the second region 112 may be 1.2 times or more the yield strength of the third region 113.

In an embodiment, the yield strength of the second region 112 may be 3.0 times or more the yield strength of the third region 113. In a specific embodiment, the yield strength of the second region 112 may be 3.3 times or more the yield strength of the third region 113.

In an embodiment, the yield strength of the second region 112 may be greater than or equal to 300 MPa. In a specific embodiment, the yield strength of the second region 112 may be greater than or equal to 330 MPa. In a more specific embodiment, the yield strength of the second region 112 may be greater than or equal to 800 MPa, and in a still more specific embodiment, the yield strength of the second region 112 may be greater than or equal to 850 MPa.

In an embodiment, the yield strength of the third region 113 may be less than or equal to 300 MPa. In a specific embodiment, the yield strength of the third region 113 may be less than or equal to 260 MPa.

In an embodiment, the mechanical strength includes the tensile strength, and the tensile strength of the second region 112 may be 1.1 times or more the tensile strength of the third region 113.

In an embodiment, the tensile strength of the second region 112 may be 2.0 times or more the tensile strength of the third region 113. In a specific embodiment, the tensile strength of the second region 112 may be 2.1 times or more the tensile strength of the third region 113.

In an embodiment, the tensile strength of the second region 112 may be greater than or equal to 500 MPa. In a specific embodiment, the tensile strength of the second region 112 may be greater than or equal to 550 MPa. In a more specific embodiment, the tensile strength of the second region 112 may be greater than or equal to 850 MPa, and in a still more specific embodiment, the tensile strength of the second region 112 may be greater than or equal to 890 MPa.

In an embodiment, the tensile strength of the third region 113 may be less than or equal to 450 MPa. In a specific embodiment, the tensile strength of the third region 113 may be less than or equal to 420 MPa.

In an embodiment, the elongation of the second region 112 may be less than 25%. In a specific embodiment, the elongation of the second region 112 may be less than 20%, and in a more specific embodiment, the elongation of the second region 112 may be less than 16%. The elongation of the third region 113 may be greater than or equal to 30%.

In an embodiment, the electrode assembly (not shown) may be received in the receiving space of the case 100. In a specific embodiment, the electrode assembly (not shown) may be wound in the form of a roll and received in the receiving space of the case 100.

In an embodiment, the electrode assembly (not shown) may include a cathode, an anode, and a separator. In a specific embodiment, the electrode assembly (not shown) may be formed by sequentially stacking a cathode, a separator, and an anode, and the stack may be wound in the form of a roll to be received in the receiving space. The stack wound in the form of a roll may be referred to as a jelly role. A cross section of the form of a roll may have a circular shape, but is not necessarily limited thereto, and may have various shapes such as an ellipse, an oblong, or a rectangle including a curve.

According to an embodiment, the cathode may include a cathode current collector and a cathode active material applied to at least one surface of the cathode current collector. The cathode current collector may include a known conductive material to the extent that it does not cause a chemical reaction in a lithium secondary battery. The cathode current collector may include, for example, one of stainless steel, nickel (Ni), aluminum (Al), titanium (Ti), copper (Cu), or an alloy thereof, and may be provided in various forms such as a film, a sheet, and foil. The cathode active material may include a material which lithium ions may be inserted into and extracted from. The cathode active material may be, for example, a lithium metal oxide.

According to an embodiment, the anode may include an anode current collector and an anode active material applied to at least one surface of the anode current collector. The anode current collector may include a known conductive material to the extent that it does not cause a chemical reaction in the lithium secondary battery. The anode current collector may include, for example, one of stainless steel, nickel (Ni), aluminum (Al), titanium (Ti), copper (Cu), and an alloy thereof, and may be provided in various forms such as a film, a sheet, and foil. The anode active material may include a material which lithium ions may be inserted into and extracted from. The anode active material may include, for example, one of a carbon-based material, such as crystalline carbon, amorphous carbon, a carbon composite, and carbon fiber, a lithium alloy, silicon (Si), and tin (Sn) or a combination thereof.

According to an embodiment, the cathode and the anode may each further include a binder and a conductive material for improving the mechanical stability and the electrical conductivity.

According to an embodiment, the separator may be included to prevent or mitigate an electrical short circuit between the cathode and the anode and to generate a flow of ions. The separator may include, for example, a porous polymer film or porous nonwoven fabric.

According to an embodiment, the electrode assembly (not shown) may be immersed in an electrolyte solution in the case 100. The electrolyte solution may be a non-aqueous electrolyte solution. The electrolyte solution may include a lithium salt and an organic solvent, and may further include an additive if necessary.

According to an embodiment, the cathode and the anode may each include an uncoated portion (a cathode uncoated portion and an anode uncoated portion, respectively) in which the active material is not applied to the current collector. According to an embodiment, the cathode uncoated portion and the anode uncoated portion may be independently formed to be pulled out in a direction toward the opening 130 and a direction toward the closed end portion 120, respectively. In an embodiment, the cathode uncoated portion and the anode uncoated portion may be formed to be simultaneously pulled out in either the direction toward the opening 130 or the direction toward the closed end portion 120.

According to an embodiment, the secondary battery 10 may further include a cathode current collector plate and an anode current collector plate. The cathode current collector plate and the anode current collector plate may be electrically connected to the cathode and the anode, respectively. According to an embodiment, the cathode current collector plate and the anode current collector plate may include a metal material such as aluminum, copper, gold, silver, or the like, but are not necessarily limited thereto.

According to an embodiment, the cathode current collector plate and the anode current collector plate may be electrically connected to the cathode and the anode through a cathode lead and an anode lead, respectively. Alternatively, the cathode current collector plate and the anode current collector plate may be directly connected to and electrically connected to the cathode uncoated portion and the anode uncoated portion by welding or the like. This structure may be referred to as a tabless structure.

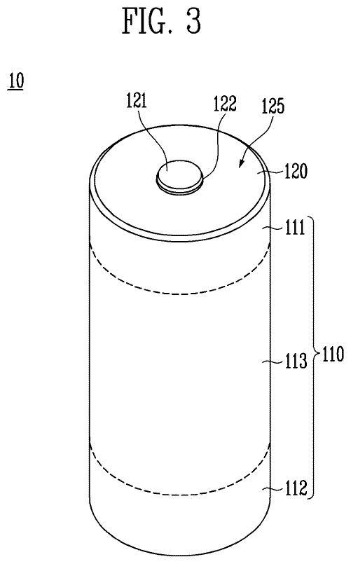

FIG. 3 is a diagram of an example of the secondary battery 10 according to an embodiment of the present disclosure viewed from one direction.

In an embodiment, the closed end portion 120 may define the cap assembly 125 together with the electrode terminal 121 and the insulating member.

According to an embodiment, the insulating member may include an insulator arranged between the electrode (cathode or anode) current collector plate and the closed end portion 120 or an insulating gasket arranged between the electrode terminal 121 and the closed end portion 120. The insulating member has an insulating property and may prevent or mitigate the electrode current collector plate or the electrode terminal from coming into contact with the case 100 to cause a short circuit. According to an embodiment, the electrode current collector plate may be, but is not necessarily limited to, a cathode current collector plate.

According to an embodiment, the electrode terminal 121 may be electrically connected to one of the electrodes. According to an embodiment, one end of the electrode terminal 121 may be electrically connected to the electrode current collector plate through a central portion of the closed end portion 120. According to an embodiment, the electrode terminal 121 may be directly connected to the electrode current collector plate, or may be connected through a separate connecting member. According to an embodiment, the other end of the electrode terminal 121 may protrude to the outside of the closed end portion 120, and may function as an external terminal. According to an embodiment, the electrode may be, but is not necessarily limited to, a cathode.

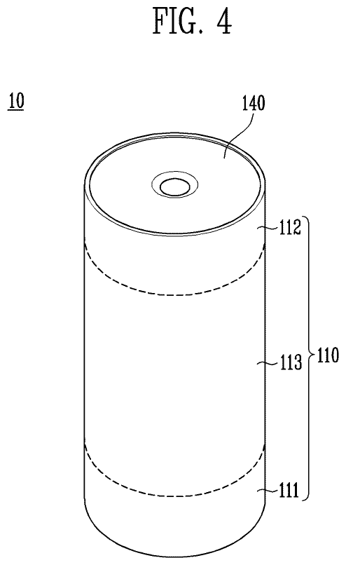

FIG. 4 is a diagram of an example of the secondary battery 10 according to an embodiment of the present disclosure viewed from another direction.

In an embodiment, the secondary battery 10 further includes the cap plate 140 which seals the opening 130, the cap plate 140 may be welded and coupled to the case 100, and the mechanical strength of the first region 111 and the second region 112 may be higher than the mechanical strength of the third region 113.

In an embodiment, the cap plate 140 may be coupled to the case 100 to seal the opening 130.

In an embodiment, the cap plate 140 may be welded and coupled to the case 100. In an embodiment, the welding is not limited as long as it corresponds to a welding method which can be used for bonding between metal materials.

In an embodiment, the cap plate 140 may further include an additional component such as an injection hole for injecting an electrolyte solution or a notching portion for venting a gas, if necessary.

In an embodiment, the cap plate 140 may include the same material as the case 100. On the other hand, the cap plate 140 may include a material different from that of the case 100.

In an embodiment, the mechanical strength of each of the first region 111 and the second region 112 may be higher than the mechanical strength of the third region 113.

In an embodiment, the mechanical strength includes the yield strength, and the yield strength of each of the first region 111 and the second region 112 may be 1.2 times or more the yield strength of the third region 113.

In an embodiment, the yield strength of each of the first region 111 and the second region 112 may be 3.0 times or more the yield strength of the third region 113. In a specific embodiment, the yield strength of each of the first region 111 and the second region 112 may be 3.3 times or more the yield strength of the third region 113.

In an embodiment, the yield strength of each of the first region 111 and the second region 112 may be greater than or equal to 300 MPa. In a specific embodiment, the yield strength of each of the first region 111 and the second region 112 may be greater than or equal to 330 MPa. In a more specific embodiment, the yield strength of each of the first region 111 and the second region 112 may be greater than or equal to 800 MPa, and in a still more specific embodiment, the yield strength of each of the first region 111 and the second region 112 may be greater than or equal to 850 MPa.

In an embodiment, the yield strength of the third region 113 may be less than or equal to 300 MPa. In a specific embodiment, the yield strength of the third region 113 may be less than or equal to 260 MPa.

In an embodiment, the mechanical strength includes the tensile strength, and the tensile strength of each of the first region 111 and the second region 112 may be 1.1 times or more the tensile strength of the third region 113.

In an embodiment, the tensile strength of each of the first region 111 and the second region 112 may be 2.0 times or more the tensile strength of the third region 113. In a specific embodiment, the tensile strength of each of the first region 111 and the second region 112 may be 2.1 times or more the tensile strength of the third region 113.

In an embodiment, the tensile strength of each of the first region 111 and the second region 112 may be greater than or equal to 500 MPa. In a specific embodiment, the tensile strength of each of the first region 111 and the second region 112 may be greater than or equal to 550 MPa. In a more specific embodiment, the tensile strength of each of the first region 111 and the second region 112 may be greater than or equal to 850 MPa, and in a still more specific embodiment, the tensile strength of each of the first region 111 and the second region 112 may be greater than or equal to 890 MPa.

In an embodiment, the tensile strength of the third region 113 may be less than or equal to 450 MPa. In a specific embodiment, the tensile strength of the third region 113 may be less than or equal to 420 MPa.

In an embodiment, the elongation of each of the first region 111 and the second region 112 may be less than 25%. In a specific embodiment, the elongation of each of the first region 111 and the second region 112 may be less than 20%, and in a more specific embodiment, the elongation of each of the first region 111 and the second region 112 may be less than 16%. The elongation of the third region 113 may be 30% or more.

According to an embodiment, the mechanical strength of the first region 111 may be the same as that of the second region 112. Alternatively, the mechanical strengths of the first region 111 and the second region 112 may be different from each other within the above-described range.

The first region 111 may be a portion defined by the cap assembly 125, and the cap assembly 125 may cause the structural deformation of the first region 111 when the internal pressure is generated from the receiving space, and the structural deformation may occur in the coupling region of the electrode terminal 121, the gasket, the case, or the like. When such structural deformation occurs, leaks or the like may occur, which may cause safety problems. When the mechanical strength of the first region 111 is high as in the above-described numerical range, the deformation of the first region 111 may be prevented or mitigated even when the internal pressure is generated, and thus the above problems may be prevented or mitigated.

The second region 112 may be a portion which is welded and coupled to the cap plate 140, and in this case, the strength of the portion may be reduced by welding. When the mechanical strength of the second region 112 is high as in the above-described numerical range, the reduction in strength during welding as described above may be prevented or mitigated.

In an embodiment, the secondary battery 10 may be a cylindrical battery having a form factor of 18650, 21700, 26650, 32700, 32140, 46110, 4680, 4695, 48110, 4875, 4880, or the like.

In a specific embodiment, the form factor may be 46110, 4680, 4695, 48110, 4875, 4880, or the like.

In a more specific embodiment, the form factor of the secondary battery 10 may be, but is not necessarily limited to, 4680 having a diameter of about 46 mm and a height of about 80 mm.

In the secondary battery 10 according to an embodiment of the present disclosure, even when the internal pressure of 30 bar, specifically 40 bar, more specifically 45 bar, and even more specifically 50 bar or more is generated from the receiving space in the case 100, the structural deformation such as the structural deformation in the cap assembly 125 and an adjacent coupling region might not be observed. In addition, even when the cap plate 140 is welded and coupled to the case 100, the reduction in the strength of the material due to welding may be prevented or mitigated.

Unlike the secondary battery 10 according to an embodiment of the present disclosure, when a case in which the mechanical rigidity of at least one of opposite ends is not secured is applied, the structural deformation may be caused at opposite ends of the case when the internal pressure of about 30 bar is generated, and thus the structural deformation may be observed at each part constituting the secondary battery.

As described above, in the secondary battery 10 according to an embodiment of the present disclosure, as the mechanical strength of opposite ends of the case 100 is further increased compared to the central portion, the pressure resistance performance may be further improved compared to the conventional battery. Even when a thin case 100 is used, the high pressure resistance performance may be exhibited.

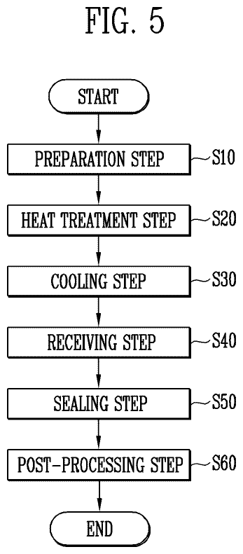

FIG. 5 is a flowchart illustrating a method of manufacturing the secondary battery 10 according to an embodiment of the present disclosure.

A method of manufacturing the secondary battery 10 according to an embodiment of the present disclosure includes: a preparation step S10 of preparing the case 100 including the cylindrical side wall portion 110 having the receiving space therein, the closed end portion 120 formed at one end of the side wall portion 110, and the opening 130 provided at the other end of the side wall portion 110; a heat treatment step S20 of performing the heat treatment on the first region 111 including one end of the side wall portion 110 in the case 100; and a cooling step S30 of cooling the case 100 on which the heat treatment is performed in the heat treatment step S20.

In an embodiment, the case 100 may include the side wall portion 110, the closed end portion 120, and the opening 130. The descriptions of the side wall portion 110, the closed end portion 120, and the opening 130 are the same as those mentioned above with reference to FIGS. 1 and 2, and therefore, repetitive descriptions will be omitted hereinafter.

In an embodiment, the side wall portion 110 may include the first region 111, the second region 112, and the third region 113. The descriptions of the first region 111, the second region 112, and the third region 113 are the same as those mentioned above with reference to FIGS. 1 and 2, and therefore, the repetitive descriptions will be omitted hereinafter.

In an embodiment, the side wall portion 110 may include a carbon steel material having a carbon content of 0.8 wt % or less. In a specific embodiment, the side wall portion 110 may include a carbon steel material having a carbon content of 0.65 wt % or less. The carbon steel material may include a low-carbon steel material having a carbon content of 0.02 wt % to 0.8 wt %, specifically 0.02 wt % to 0.65 wt %. The carbon steel material may include an ultra-low carbon steel material having a carbon content of 0.02 wt % to 0.2 wt %.

In an embodiment, the side wall portion 110 may include a plated carbon steel material. The plating treatment is for preventing corrosion of the side wall portion 110, and a known technique may be employed without limitation as long as it corresponds to plating treatment of carbon steel for corrosion prevention. According to an embodiment, the side wall portion 110 may include a nickel-plated carbon steel material, but is not necessarily limited thereto.

In an embodiment, the preparation step S10 may refer to a step of preparing the case 100 including the cylindrical side wall portion 110 having the receiving space therein, the closed end portion 120 formed at one end of the side wall portion 110, and the opening 130 provided at the other end of the side wall portion 110.

In an embodiment, in the preparation step S10, the case 100 may be prepared by a deep drawing process in which at least a part of a sheet or plate of a material constituting the case 100 is pressed with a punch and molded. Alternatively, in the preparation step S10, the case 100 may be prepared by bending the sheet of the material constituting the case 100 and then welding and coupling the remaining components thereto.

As described above, when the side wall portion 110 includes a low-carbon steel or ultra-low-carbon steel material having a carbon content of 0.8 wt % or less, the processability may be excellent due to the high ductility. However, as described above, when the above material is employed as is as the case 100 of the secondary battery 10, the mechanical rigidity may be inferior.

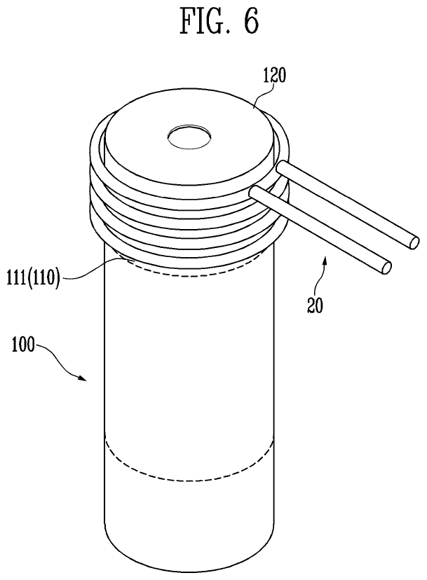

FIG. 6 is a diagram illustrating an embodiment of the heat treatment step S20.

In an embodiment, the heat treatment step S20 may mean a step of performing the heat treatment on the first region 111 including one end of the side wall portion 110 in the case 100.

In an embodiment, the heat treatment step S20 may be performed by high-frequency induction heating. Alternatively, the heat treatment step S20 may be performed by bringing a heat source close to the case 100, injecting heat or high-temperature gas, or irradiating a laser.

Referring to FIG. 5, in an embodiment, when the heat treatment step S20 is performed by high-frequency induction heating, the heat treatment step S20 may be performed by a high-frequency induction heating device including an induction coil 20. After the induction coil 20 is arranged adjacent to the first region 111 of the side wall portion 110, the first region 111 may be heat-treated by operating the high-frequency induction heating device.

In an embodiment, the heat treatment step S20 includes a heating step S21 of heating the first region 111 until a reference temperature is reached, and the reference temperature may be 250° C. to 500° C. In a specific embodiment, the reference temperature may be 350° C. to 500° C., and in a more specific embodiment, the reference temperature may be 450° C. to 500° C.

In an embodiment, the heat treatment step S20 further includes a holding step S22 of leaving the first region 111, heated to the reference temperature in the heating step S21, to stand, and the holding step S22 may be performed for 1 to 10 seconds. The holding step S22 may be performed by allowing the case 100, on which the heating step S21 is completed, to remain as it is.

In an embodiment, the cooling step S30 may refer to a step of cooling the case 100 on which the heat treatment in the heat treatment step S20 is performed.

In an embodiment, in the cooling step S30, the case 100 may be cooled at a cooling rate of 5° C./sec to 500° C./sec. In a specific embodiment, in the cooling step S30, the case 100 may be cooled at a cooling rate of 30° C./sec to 500° C./sec, and in a more specific embodiment, in the cooling step S30, the case 100 may be cooled at a cooling rate of 80° C./sec to 500° C./sec.

The structure of the carbon steel constituting the material of the case 100 does not transform into pearlite or bainite, but may all transform into martensite within the ranges of the heat treatment temperature and the standing time in the heat treatment step S20 and the cooling rate in the cooling step S30. Accordingly, the mechanical rigidity of the first region 111 of the case 100 may be achieved as described above, and specifically, the physical properties of the first region 111 as described above with respect to the case 100 of the secondary battery 10 according to an embodiment of the present disclosure may be implemented.

In an embodiment, in the cooling step S30, the case 100 may be cooled by an air-cooling method or a water-cooling method.

In a specific embodiment, in the cooling step S30, the case 100 may be cooled by a water-cooling method.

Alternatively, in a specific embodiment, in the cooling step S30, the case 100 may be cooled by an air-cooling method.

In an embodiment, when the case 100 is cooled by the water-cooling method, the water-cooling method may be performed by spraying cooling water on the front surface corresponding to the first region 111 of the case 100 on which the heat treatment is performed in the heat treatment step S20. Alternatively, the water-cooling method may be performed by immersing the case 100 in cooling water.

In an embodiment, when the case 100 is cooled by the air-cooling method, the air-cooling method may be performed by leaving the case 100 on which the heat treatment is performed in the heat treatment step S20 stand in a room temperature environment. Alternatively, the air-cooling method may be performed by supplying cold air to the case 100.

In an embodiment, the heat treatment step S20 and the cooling step S30 are sequentially performed, but may be performed for 5 seconds to 99 seconds. In a specific embodiment, the heat treatment step S20 and the cooling step S30 may be performed for 10 seconds to 90 seconds, and in a more specific embodiment, the heat treatment step S20 and the cooling step S30 may be performed for 10 seconds to 50 seconds. When the heat treatment step S20 and the cooling step S30 are performed for a time longer than the above-described numerical range, the heat treatment effect may be transferred to a region other than the first region 111, and when the heat treatment step S20 and the cooling step S30 are performed for a time shorter than the above-described numerical range, the heat treatment effect may be insignificant.

In an embodiment, the heat treatment step S20 may refer to a step of performing the heat treatment on the second region 112 including the other end of the side wall portion 110 in the case 100. In the above case, specific matters such as the heat treatment step and the cooling step are the same as those described above, and therefore, the repetitive descriptions will be omitted hereinafter.

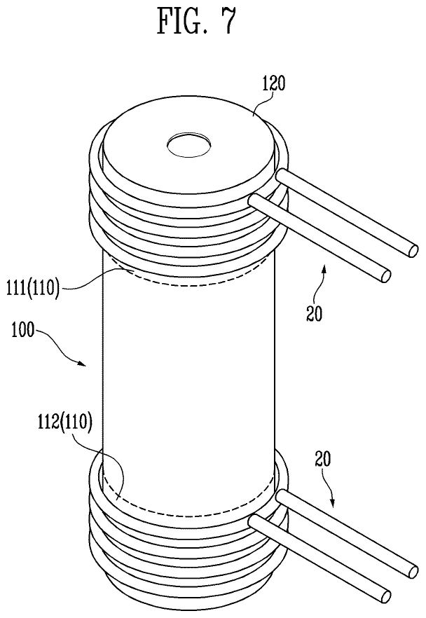

FIG. 7 is a diagram illustrating another embodiment of the heat treatment step S20.

In an embodiment, the heat treatment step S20 may refer to a step of performing the heat treatment on the first region 111 including one end of the side wall portion 110 in the case 100 and the second region 112 including the other end of the side wall portion 110 in the case 100.

In an embodiment, the heat treatment step S20 may be performed by high-frequency induction heating. Alternatively, the heat treatment step S20 may be performed by bringing a heat source close to the case 100, injecting heat or high-temperature gas, or irradiating a laser.

Referring to FIG. 6, in an embodiment, when the heat treatment step S20 is performed by high-frequency induction heating, the heat treatment step S20 may be performed by a high-frequency induction heating device including the induction coil 20. After the induction coil 20 is arranged adjacent to each of the first region 111 and the second region 112 of the side wall portion 110, the high-frequency induction heating device is operated, so that the first region 111 may be heat-treated simultaneously with the second region 112.

In an embodiment, in the cooling step S30, the case 100 may be cooled by an air-cooling method or a water-cooling method. In a specific embodiment, in the cooling step S30, the case 100 may be cooled by a water-cooling method.

In an embodiment, when the case 100 is cooled by the water-cooling method, the water-cooling method may be performed by spraying cooling water on each of the front surfaces corresponding to the first region 111 and the second region 112 of the case 100 on which the heat treatment is performed in the heat treatment step S20. Alternatively, the water-cooling method may be performed by immersing the case 100 in cooling water.

In addition, the above descriptions of the heat treatment step S20 and the cooling step S30 may be applied without limitation.

In an embodiment, the manufacturing method may further include a receiving step S40 of receiving the electrode assembly (not shown) wound in the form of a roll in the receiving space of the case 100 cooled in the cooling step S30.

In an embodiment, the receiving step S40 may receive the electrode assembly (not shown) after receiving an insulator and a current collector plate in the receiving space.

In an embodiment, the manufacturing method may further include a sealing step S50 of sealing the receiving space by coupling the cap plate 140 to the opening 130 of the case 100 in which the electrode assembly (not shown) is received.

In an embodiment, the manufacturing method may further include a step of injecting the electrolyte solution into the receiving space by the sealing step S50.

In an embodiment, the manufacturing method may further include, after injecting the electrolyte solution as described above, the steps of activating, degassing, and sealing an electrolyte solution injection port.

The steps including the steps after the sealing step S50 may be collectively referred to as a post-processing step S60.

In an embodiment, the descriptions of the electrode assembly (not shown) and the cap plate 140 are the same as those mentioned above with reference to FIGS. 1 and 2, and thus, the repetitive descriptions will be omitted hereinafter.

In the manufacturing method, after performing the heat treatment step S20 and the cooling step S30 on the case 100, the electrode assembly (not shown) may be received in the case 100. When the electrode assembly (not shown) is first received in the case 100 and then the heat treatment step S20 and the cooling step S30 are performed on the case 100, the electrode assembly (not shown) may be damaged by heat applied during the heat treatment. By performing the heat treatment step S20 and the cooling step S30 on the case 100 and then performing the receiving step S40 and/or the sealing step S50, the reduction in strength when the cap plate 140 is welded to the case 100 may be prevented or mitigated.

The secondary battery 10 manufactured according to the method of manufacturing the secondary battery 10 according to the embodiment of the present disclosure may implement the mechanical properties and characteristics of the secondary battery 10 according to the embodiment of the present disclosure described above.

The secondary battery according to an embodiment of the present disclosure may be used not only for a battery cell used as a power source of a small device, but also preferably as a unit cell for a battery module of a medium or large device including a plurality of battery cells. Examples of the small device may include a mobile phone, a notebook computer, a camera, and the like, and examples of the medium or large device may include an electric vehicle, a hybrid electric vehicle, a plug-in hybrid electric vehicle, a power storage system, and the like, but are not limited thereto.

Hereinafter, embodiments of the present disclosure will be further described with reference to specific experimental examples. Inventive examples and comparative examples included in the experimental examples are merely illustrative of the present invention and do not limit the scope of the appended claims, and it is obvious to those skilled in the art that various changes and modifications to the inventive examples are possible within the scope and technical spirit of the present disclosure, and it is natural that such changes and modifications fall within the scope of the appended claims.

### Inventive Examples

### Inventive Example 1

A nickel-plated carbon steel sheet having a carbon content of 0.65 wt % was deep drawn, and then cut and processed to prepare a case including a side wall portion and a closed end portion. An induction coil was placed in a first region including one end adjacent to the closed end in the side wall portion as shown in FIG. 4, and then heated to 500° C. After the heating was completed, the operation of the induction coil was stopped, and then cooled to room temperature at a rate of 80° C./sec by spraying cooling water on the first region to prepare a heat-treated case.

### Inventive Example 2

A heat-treated case was prepared in the same manner as in Inventive Example 1, except that after the heating was completed, the induction coil was released, and then the case was exposed to a room temperature environment and cooled to room temperature at a rate of 30° C./sec.

### Inventive Example 3

A heat-treated case was prepared in the same manner as in Inventive Example 1, except that after the heating was completed, the operation of the induction coil was stopped, and then left to stand for 200 seconds and cooled to room temperature at a rate of 2° C./sec.

### Comparative Example

A nickel-plated carbon steel sheet having a carbon content of 0.65 wt % was deep drawn, cut, and processed to prepare a case including a side wall portion and a closed end portion without any post-treatment process.

### Evaluation Example

After obtaining specimens corresponding to the first region of each case prepared in Inventive Examples 1 to 3 and a specimen (each subsize specimen) in any region of the case in Comparative Example, the yield strength and the tensile strength were evaluated in accordance with ASTM E8 using a Universal Testing Machine (UTM, Z010 TN, ZwickRoell), and the elastic modulus and the elongation were evaluated by applying a 2% offset of the stress-strain curve. The evaluation results are shown in Table 1 below.

TABLE 1

| | Yield | Tensile | Elastic | |
|---|---|---|---|---|
| | strength | strength | modulus | Elongation |
| | (MPa) | (MPa) | (MPa) | (%) |
| Inventive Example 1 | 860 | 890 | 9100 | 15 |
| Inventive Example 2 | 330 | 500 | 18300 | 21 |
| Inventive Example 3 | 160 | 250 | 8360 | 32 |
| Comparative Example | 260 | 420 | 12360 | 30 |

As shown in Table 1 above, in the case of each of Inventive Examples 1 and 2 prepared according to an embodiment of the present disclosure, the portions subjected to heat treatment and cooling exhibited the superior yield strength and tensile strength compared to that of Comparative Example in which no separate post-treatment process was performed, and in particular, the case of Inventive Example 1 cooled by a water-cooling method after heat treatment, the yield strength and the tensile strength were significantly superior to those of Comparative Example.

On the other hand, in Inventive Example 3, the heat treatment and cooling of the carbon steel were the same as in Inventive Examples 1 and 2, but the case prepared according to Inventive Example 3 was cooled by furnace cooling, and thus the mechanical strength thereof was somewhat inferior to that of Inventive Examples 1 and 2.

The secondary battery manufactured according to the method of manufacturing the secondary battery according to an embodiment of the present disclosure has the improved mechanical strength of at least one of a coupling portion between the case and the closed end portion or a coupling portion between the case and the cap plate, so that the structural deformation does not occur and the stability may be maintained even at the high internal pressure of 30 bar, specifically 40 bar, more specifically 45 bar, and even more specifically 50 bar.

The descriptions as set forth above are merely examples of applying the principles of the present disclosure, and other configurations may be further included without departing from the scope of the present disclosure.

What is claimed is:

1. A secondary battery, comprising:
a case including a cylindrical side wall portion having a receiving space therein, a closed end portion formed at one end of the side wall portion, and an opening provided at another end of the side wall portion; and
an electrode assembly received in the receiving space,
wherein the side wall portion includes a first region including the one end, a second region including the other end, and a third region including a region other than the first region and the second region, and
wherein mechanical strength of the first region is higher than mechanical strength of the third region.

2. The secondary battery of claim 1, wherein the side wall portion includes a carbon steel material having a carbon content of 0.8 wt % or less.

3. The secondary battery of claim 1, wherein the mechanical strength includes yield strength, and
wherein yield strength of the first region is 1.2 times or more yield strength of the third region.

4. The secondary battery of claim 3, wherein the yield strength of the first region is 3.0 times or more the yield strength of the third region.

5. The secondary battery of claim 1, wherein the mechanical strength includes tensile strength, and
wherein tensile strength of the first region is 1.1 times or more tensile strength of the third region.

6. The secondary battery of claim 5, wherein the tensile strength of the first region is 2.0 times or more the tensile strength of the third region.

7. The secondary battery of claim 1, further comprising a cap plate sealing the opening,
wherein the cap plate is welded and coupled to the case, and
wherein mechanical strength of each of the first region and the second region is higher than the mechanical strength of the third region.

8. A method of manufacturing a secondary battery, comprising:
a preparation step of preparing a case including a cylindrical side wall portion having a receiving space therein, a closed end portion formed at one end of the side wall portion, and an opening provided at another end of the side wall portion;
a heat treatment step of performing heat treatment on a first region including the one end of the side wall portion of the case; and
a cooling step of cooling the case on which the heat treatment is performed in the heat treatment step.

9. The method of claim 8, wherein the side wall portion includes a carbon steel material having a carbon content of 0.8 wt % or less.

10. The method of claim 8, wherein the heat treatment step includes a heating step of heating the first region until a reference temperature is reached, and
wherein the reference temperature is 250° C. to 500° C.

11. The method of claim 10, wherein the heat treatment step further includes a holding step of leaving the first region, heated to the reference temperature in the heating step, to stand, and
wherein the holding step is performed for 1 to 10 seconds.

12. The method of claim 8, wherein, in the cooling step, the case is cooled at a cooling rate of 5° C./sec to 500° C./sec.

13. The method of claim 8, wherein, in the cooling step, the case is cooled by a water-cooling method.

14. The method of claim 8, wherein, in the heat treatment step, heat treatment is performed on both the first region including the one end of the side wall portion of the case and the second region including the other end of the side wall portion of the case.

15. The method of claim 8, further comprising a receiving step of receiving an electrode assembly wound in a form of a roll in the receiving space of the case cooled in the cooling step.
